(19) United States
(12) Patent Application Publication
(10) Pub. No.: US 2026/0292009 A1
(43) Pub. Date: Sep. 24, 2026

(54) PDU SET INFORMATION RTP HEADER EXTENSION

(71) Applicant: InterDigital VC Holdings, Inc., Wilmington, DE (US)

(72) Inventors: Srinivas GUDUMASU, Montreal (CA); Ahmed HAMZA, Coquitlam (CA)

(73) Assignee: InterDigital VC Holdings, Inc., Wilmington, DE (US)

(21) Appl. No.: 19/474,342

(22) PCT Filed: Apr. 10, 2024
(86) PCT No.: PCT/US2024/023855

§ 371 Date: Oct. 10, 2025

Related U.S. Application Data
(60) Provisional application No. 63/495,203, filed on Apr. 10, 2023.

(51) Int. Cl. H04L 65/65; H04L 47/2441; H04L 65/70

(52) U.S. Cl. CPC H04L 65/65; H04L 47/2441; H04L 65/70

(57) ABSTRACT

A method for signaling for a PDU set RTP header extension (HE) may comprise negotiating, between an AS and an AF, usage of a RTP HE. The method may comprise generating, by the AF, a RTP HE ID and sending, by the AF to the AS, the RTP HE ID. The method may comprise sending, by the AS to the AF, a RTP HE ID. The method may comprise sending, by the AF to a NEF, usage of the PDU set RTP HE and sending, by the NEF to a PCF, the PDU set RTP HE. The method may comprise constructing, by the PCF, a PCC rule including PDU set RTP HE usage information and sending, by the PCF, the PCC rule to a SMF. The method may comprise sending, by the SMF to the UPF, the PDU set RTP HE usage information.

### RELATED APPLICATIONS

The present application claims the benefit of and priority to U.S. Provisional Patent Application No. 63/495,203, entitled “PDU Set Information RTP Header Extension,” filed Apr. 10, 2023, the entirety of which is incorporated by reference herein.

### BACKGROUND

Packet data unit (PDU) sets allow carriage of large application layer data across a plurality of PDUs. However, the PDUs each carrying a portion of the data need to be identified as part of the set, or else it may be difficult if not impossible to reassemble the data fragments or portions. Classic transport layer packet fragmentation protocols may be inadequate for PDU sets, as they lack information related to set importance, variable bit lengths, and other features.

### SUMMARY

To address the above and other problems, the present disclosure is directed to implementations of systems and methods for signaling packet data unit (PDU) set information via a real-time protocol (RTP) header extension (HE). In particular, implementations of the systems and methods discussed herein provide for signaling PDU set information related to set importance or priority; discardability, including syntax, semantics and guidelines of discardability flags; how a network node, such as a user plane function (UPF), may identify PDU set information presence in PDUs; and how to handle variable length fields such as PDU sequence numbers and/or PDU set sequence numbers.

In some aspects, the method may comprise negotiating, between an Application Server (AS) and an Application Function (AF), usage of a RTP HE for transmitting PDU set information between the AS and a User Plane Function (UPF). The method may comprise generating, by the AF, a RTP HE identification (ID) and sending, by the AF to the AS, the RTP HE ID. The method may comprise using, by the AS, the RTP HE ID during a RTP session creating time. The method may comprise sending, by the AS to the AF, a RTP HE ID. The method may comprise sending, by the AF to a Network Exposure Function (NEF), usage of the PDU set RTP HE. The sending, by the AF to the NEF, usage of the PDU set RTP HE, may comprise invoking an application programming interface (API) that may comprise sending, from the AF to the NEF, a Nnef_AFsessionWithQOS request, and receiving, by the AF from the NEF, a Nnef_AFsessionWithQoS response. The method may comprise sending, by the NEF to a Policy Control Function (PCF), the PDU set RTP HE. The sending, by the NEF to the PCF, the PDU set RTP HE, may comprise invoking an API that may comprise sending, from the NEF to the PCF, a Npcf_PolicyAuthorization request, and receiving, by the NEF from the PCF, a Npcf_PolicyAuthorization response. The method may comprise constructing, by the PCF, a policy and charging control (PCC) rule including PDU set RTP HE usage information. The method may comprise sending, by the PCF, the PCC rule to a Session Management Function (SMF). The PCF may send the PCC rule to the SMF in response to the SMF invoking an API that may comprise sending, from the SMF to the PCF, a Npcf_SMPolicyControl request, and receiving, by the PCF from the SMF, a Npcf_SMPolicyControl response. The method may comprise sending, by the SMF to the UPF, the PDU set RTP HE usage information. The PDU set RTP HE usage information may be sent from the SMF to the UPF is in a N4 message. The negotiating, between the AS and AF, usage of a RTP HE may be performed via an M3 interface.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 shows an example RTP header extension using a one-byte header format, according to some embodiments;

FIG. 3 shows an example RTP header extension using a two-byte header format, according to some embodiments;

FIG. 4 shows an example NAL unit type octet in an RTP packet payload, according to some embodiments;

FIG. 5 shows an example structure of a HEVC NAL Unit Header, according to some embodiments;

FIG. 6 shows an example structure of a VVC NAL Unit Header, according to some embodiments;

FIG. 7 shows an example procedure for configuring the UPF, according to some embodiments;

FIG. 8 shows an example of a RTP header extension using a one-byte header format with slice number signaling, according to some embodiments;

FIG. 9 shows an example of an RTP header extension using a two-byte header format with slice number signaling, according to some embodiments;

FIG. 10 shows another example of an RTP header extension using a one-byte header format with slice number signaling, according to some embodiments;

FIG. 11 shows another example of an RTP header extension using two-byte header format with slice number signaling, according to some embodiments; and FIG. 12 shows a flow chart of a method for signaling PDU set information via an RTP header extension, according to some embodiments.

### DETAILED DESCRIPTION

Prior to discussing specific implementation details of systems and methods for signaling packet data unit set information, it may be helpful to briefly discuss a system environment in which these systems and methods may be implemented.

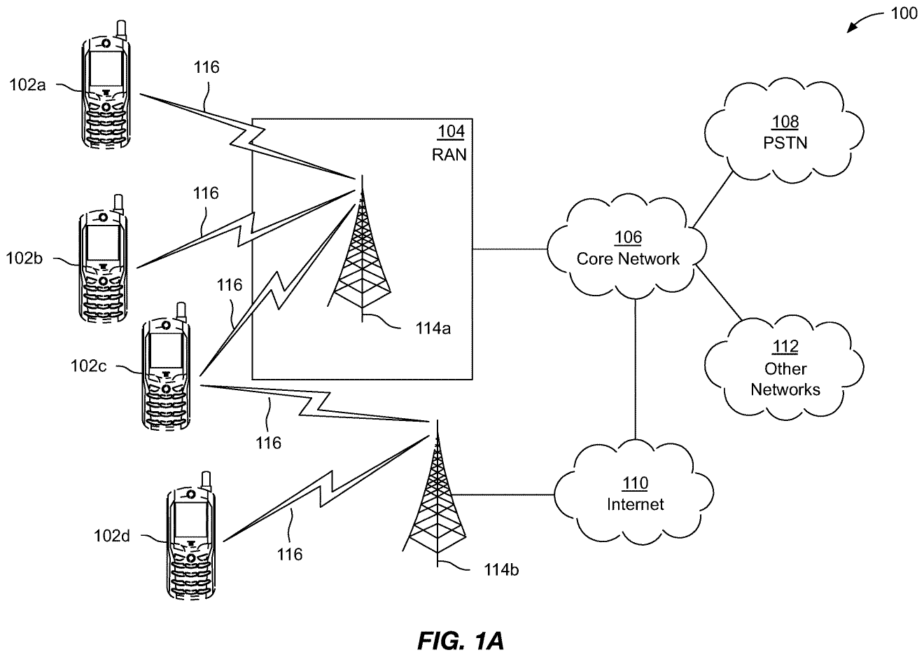

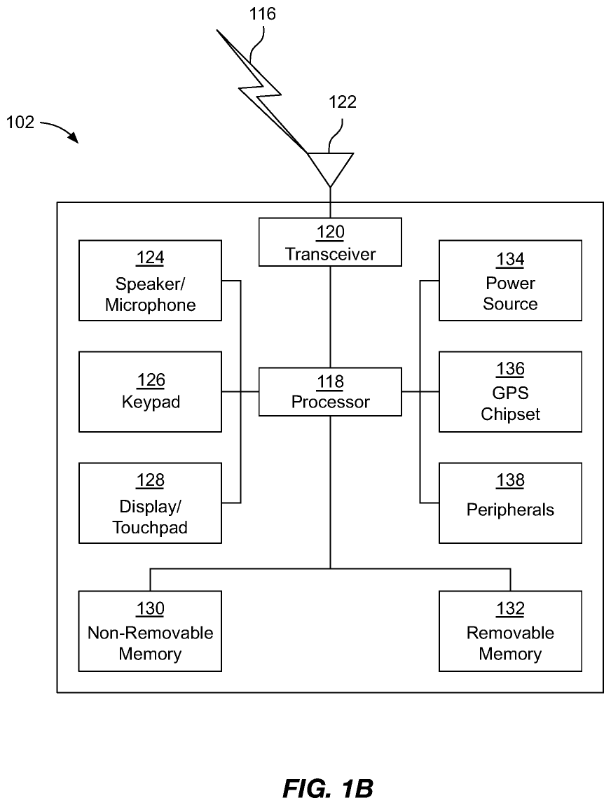

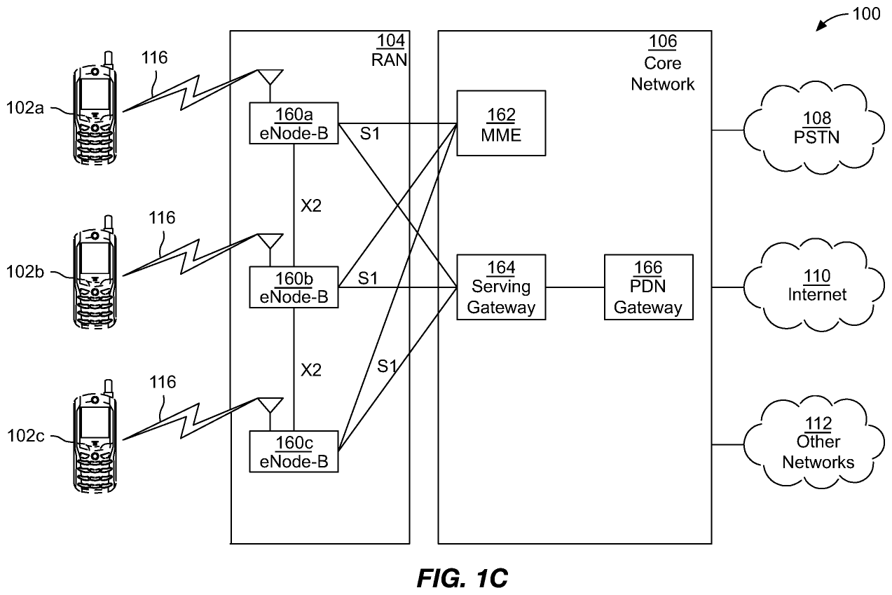

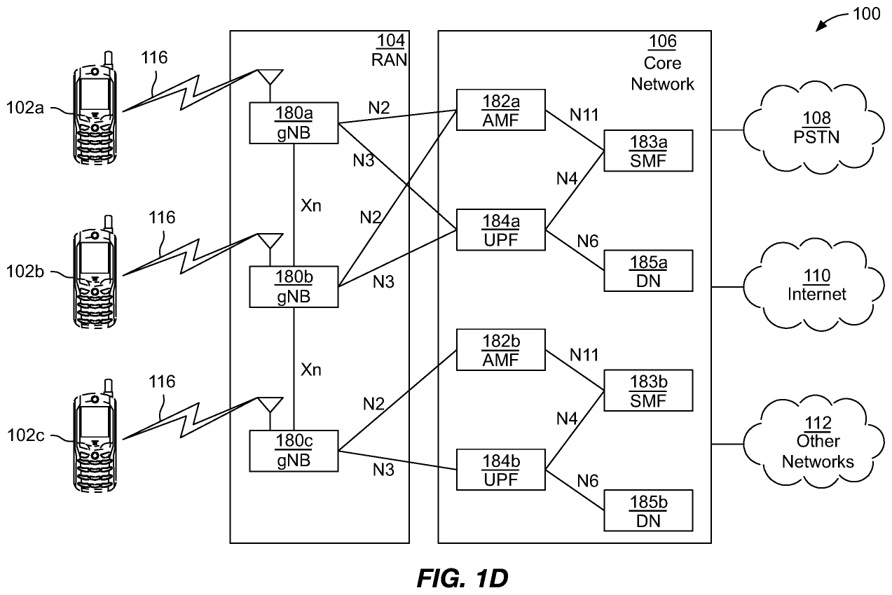

Referring first to FIG. 1A, illustrated is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUS 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following abbreviations and acronyms may be referred to:
AF Application Function
AS Application Server
EOB End of Burst
GTP-U GPRS Tunneling Protocol User Plane Protocol
HE Header Extension
PCC Policy and Charging Control
PCF Policy Control Function
PDU Packet Data Unit
RTP Real-Time Protocol
SMF Session Management Function
SRTP Secure Real-Time Protocol
UE User Equipment
UPF User Plane Function
XR Extended Reality

As discussed above, packet data unit (PDU) sets allow carriage of large application layer data across a plurality of PDUs. However, the PDUs each carrying a portion of the data need to be identified as part of the set, or else it may be difficult if not impossible to reassemble the data fragments or portions. Classic transport layer packet fragmentation protocols may be inadequate for PDU sets, as they lack information that may be necessary or desirable for use. For example, in some implementations, it may be useful to communicate a PDU Set sequence number or sequence number of a PDU within the PDU Set; boundaries of the PDU set (e.g., start and/or end of PDU Set marking, PDU Set size in number of PDUs, etc.); PDU Set importance or priority (either on an absolute scale or relative to other PDUs); size in bytes of a PDU Set; an indication that the PDU may be discarded without significant impact to the reconstructed media, etc.

To address the above and other problems, the present disclosure is directed to implementations of systems and methods for signaling packet data unit (PDU) set information via a real-time protocol (RTP) header extension (HE). In particular, implementations of the systems and methods discussed herein provide for signaling PDU set information related to set importance or priority; discardability, including syntax, semantics and guidelines of discardability flags; how a network node, such as a user plane function (UPF), may identify PDU set information presence in PDUs; and how to handle variable length fields such as PDU sequence numbers and/or PDU set sequence numbers. For example, in some embodiments, the systems and methods discussed herein provide signaling of a PDU set importance/priority field; signaling of a PDU set discardability flag; syntax, semantics and guidelines on how to set the discardability flag; identification of PDU Set information RTP header extension presence in a received PDU or PDUs and signaling between the AS and UPF about the use of PDU Set RTP header extension for carriage of PDU Set information; and the number of bits required for signaling a PDU Sequence Number (PSN) and PDU Set Sequence Number (PSSN).

In some implementations, the RTP header extension mechanism defined in RFC8285 may be extended to define a new RTP header extension to carry PDU Set information. In various implementations, the RTP header extension (HE) may be defined with one-byte extension and two-byte extension formats.

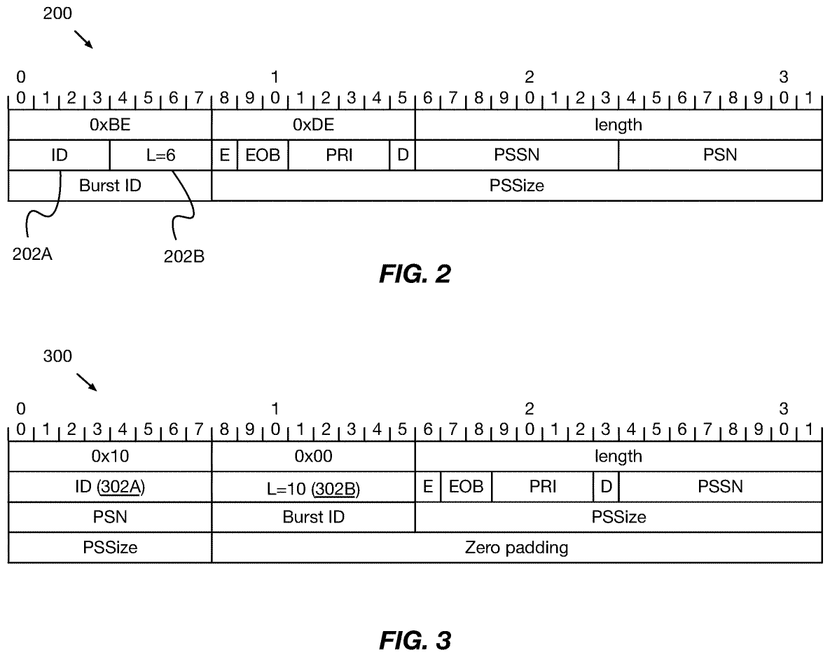

The syntax and semantics of the PDU Set information header extension may be defined as shown in FIG. 2 and FIG. 3. Referring first to FIG. 2, illustrated is a RTP header extension 200 using a one-byte header format. The first two bytes (0xBEDE) are used to identify that the packet includes an RTP one-byte header extension, and the fifth byte (starting the header extension itself) includes a 4-bit identifier 202A and 4-bit length field 202B. The length field 202B specifies the remaining header length in bytes-minus-one (i.e. a length of “0” would indicate a 1 byte header extension following the length field 202B). In the example of FIG. 2, the length of 6 indicates 7 bytes of the header extension are included (i.e. bytes 6 through 12).

FIG. 3 shows a RTP header extension 300 using a two-byte header format. The first 12 bits (0x100) specify the two-byte header format with the next 4 bits being a local application-specific identifier. The identifier 302A at byte 5 is expanded to a byte in length, and the length is similarly expanded to utilize byte 6. The length field 302B specifies the remaining header length, but without the minus one of the one-byte format (i.e. a length of 0 would indicate no bytes follow after the length byte). In the example shown, there are 10 additional bytes after the length field 302B in the header extension.

Header extensions in either format may include some or all of the following fields:
An end (E) flag which may be 1 bit. The E flag may indicate if the current PDU is the last PDU of the PDU Set or not. A value of 1 may indicate that this PDU is the last PDU of the PDU Set. A value of 0 may indicate that this PDU is not the last PDU of the PDU Set.
An end-of-burst (EOB) field, which may be 2 bits. A value of the EOB may be set to 0x 01 for the last PDU of the data burst. When this flag is set to 0x00 the current PDU is not the last PDU of the data burst. When this flag is set to 0x10 the EOB indication is not indicated in the PDU Set information RTP header extension. When this flag is set to 0x11 the PDU is part of the last PDU set of the data burst. For all PDUs of the last PDU set of the data burst, this flag value may be set to 0x11.
An importance or priority (PRI) field, which may be 4 bits. This field may indicate the priority of a PDU set compared with other PDU sets with in the same stream. The lower the value of the priority field the higher the importance. For example, a PDU set with priority value 0 may be more important compared to a PDU set with priority value 1.
A discardability (D) field, which may be 1 bit. This field may indicate if this PDU set can be discarded without significant impact on the decoding of the media. For example, when the field is set to 1, the PDU set may be discarded without significant impact on the decoding and reconstruction, and when the field is set to 0, the PDU set may not be discarded.
A PDU Set sequence number (PSSN), which may be 8 bits. This field may comprise a value that indicates the sequence number of the PDU set to which the current PDU belongs. When a video frame is coded using multiple slices, each PDU set contains the coded slice data.
A PDU sequence number (PSN), which may be 8 bits. The field may indicate the sequence number of the current PDU with in the PDU set. When a video frame is coded using a single slice the number of PDUs in a PDU set will be higher otherwise this number is small.
A Burst identifier (ID), which may be 8 bits. This value may be set to an identifier for a burst. PDUs which are intended to be sent in a single burst (e.g. which correspond to the same displayed time), should have the same burst ID.

In some implementations, a PDU Set importance or a priority field may be set by an application server or a source UE for a PDU. For example, in some implementations, PDU sets that contain audio data may be set with a highest importance compared with other media PDU sets. For example, PDU sets that belong to audio media may be set with a priority value 0x00. As short audio errors or delays are typically more perceivable and more annoying than short video errors or delays, it may be beneficial to transmit audio data at the highest priority or importance.

In some implementations, PDU sets that contain reference frames present in the video bitstream (e.g. I-frames or frames encoded with only intra-frame compression) are set with a higher priority compared with non-reference frames (e.g. P-frames or B-frames, encoded based on a previous frame or bidirectionally encoded based on prior and subsequent frames) present in the video bitstream, as the reference frames are needed for decoding an entire group of frames (typically lasting dozens of frames or seconds). The Intra Random Access Pictures (IRAP) pictures such as Instantaneous Decoder Refresh (IDR) frames, Clean Random Access (CRA) frames, Broken Link Access (BLA) frames and Gradual decoding refresh (GDR) frames are set with higher priority. The priority value for such pictures can be set to 0x01.

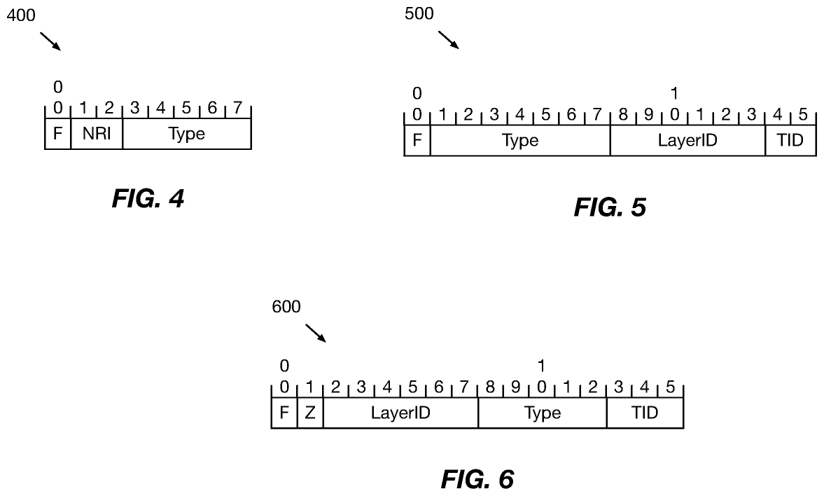

Various implementations of video codecs may indicate picture types in a header, such as a network abstraction layer (NAL) unit header. The NAL unit header may be carried in an RTP packet, such as in a header extension block or a payload. An example of a NAL unit header 400, such as those used in H.265 coding, is illustrated in FIG. 4. The first bit is a forbidden bit (i.e. left as 0) to identify any transmission errors. The next two bits (NAL Reference Identifier or NRI, sometimes referred to as nal_ref_idc) indicate whether the NAL unit following the header is a reference frame or field, and the following 5 bits indicate the NAL unit type, specifying the type of data structure (e.g. coded slices of partitions, picture or sequent parameter set, etc.).

For example, in a VVC bitstream, a nal_unit_type field with values ranging from 7 to 11 (inclusive) are Intra Random Access Pictures (IRAP) pictures. When the Type field value in the network abstraction layer (NAL) Unit header of a RTP packet is in the range 7 to 11 (inclusive), then the corresponding PDUs in that PDU set may be set with a higher priority value in the RTP header extension, for example with 0x01.

The parameter set NAL units such as Sequence Parameter Set (SPS), Picture Parameter Set (PPS), Video Parameter Set (VPS) are important for decoding the bitstream. So PDU sets with a payload Type field value in the NAL Unit header of a RTP packet corresponding to such parameter sets (e.g. the range 14 to 16 (inclusive) for VVC bitstreams) may be set with a higher priority in the RTP header extension. The priority value for such PDU sets may be set to 0x01.

Similarly, in a HEVC bitstream, a nal_unit_type field with values ranging from 16 to 23 (inclusive) are Intra Random Access Pictures (IRAP) pictures. When the Type field value in the NAL Unit header of RTP packet is in the range 16 to 23 (inclusive), then the corresponding PDUs in that PDU set may be set with a higher priority value in the RTP header extension, for example with 0x01.

Likewise, for HEVC bitstreams, parameter set NAL units such as Sequence Parameter Set (SPS), Picture Parameter Set (PPS), Video Parameter Set (VPS) may be identified with a corresponding Type field value in the NAL Unit header of RTP packet in the range 32 to 34 (inclusive). As discussed above, as these information sets are important for decoding the bitstream, they may be set with a higher priority in the RTP header extension. The priority value for such PDU sets may be set to 0x01.

In an H.264 bitstream, a nal_unit_type field with value 5 is an Intra Random Access Pictures (IRAP) picture. When the Type field value in the NAL Unit header of the RTP packet is 5, then the corresponding PDUs in that PDU set may be set with a higher priority value in the RTP header extension, for example with 0x01.

H.264 parameter set NAL units such as Sequence Parameter Set (SPS) and Picture Parameter Set (PPS) may be indicated with a payload Type field value equal to 7, 8, 13 or 15 in the NAL Unit header of a RTP packet. As with other video codecs, as these parameter sets are important for decoding, they may be sent with a higher priority in the RTP header extension. The priority value for such PDU sets may be set to 0x01.

In video coding, temporal scalability is an option to decode only some of the frames in a video stream instead of the whole stream. This enables a media server to reduce the bitrate sent towards viewers who does not have enough bitrate or CPU to handle the whole stream. Pictures with a lowest temporal identifier value are used as reference pictures in the bitstream.

Modern video codecs such as AVC, HEVC and VVC include an improved support of temporal scalability, by inclusion of the signaling of a Temporal ID (TID) in the NAL unit header. The support of temporal scalability comes with the restriction that pictures of a particular temporal sub-layer cannot be used for inter-prediction reference by pictures of a lower temporal sub-layer, the sub-bitstream extraction process, and the requirement that each sub-bitstream extraction output be a conforming bitstream.

Hence, pictures with a highest Temporal ID cannot be used as reference pictures and can be discarded at the network level when the throughput is not good or network conditions are unstable. For example, a device or node generating the PDU set for transmission may set a discard flag on the PDU set, and may monitor network conditions prior to transmission of the PDU set. In response to network conditions matching a discard policy (e.g. if throughput is reduced below a threshold; if error rates exceed a threshold; if interference or congestion is detected; or any other such instance in which reducing the amount of data to be transmitted is desired), the device may discard the PDU set (i.e. without transmitting the PDU set). Similarly, in some implementations, a downstream or intermediary device or node receiving the PDU set for further transmission may identify the discard flag and similarly monitor network conditions. If the conditions match a discard policy prior to retransmission of the PDU set, the downstream or intermediary device or node may discard the PDU set.

PDU sets with TID value 1 (lowest possible value) may be sent with a higher priority. The priority value for such pictures may be set to 0x01 (for IRAP pictures) or 0x02 (for non IRAP pictures). PDU sets with higher TID values in the bitstream are set with lower priority compared with the PDU sets with lower TID values. PDU sets with a highest TID value in the bitstream are set with a lowest priority.

Another example of a NAL unit header 500 in an RTP packet payload, such as those used by HEVC implementations, is shown in FIG. 5. A TID field, which may be referred to as nuh_temporal_id_plus1 in some implementations, specifies the temporal identifier of the NAL unit plus 1 (e.g. with the lowest possible value of 1, corresponding to a Temporal ID of 0).

In some implementations, NAL units with highest Temporal ID or TID field value may be set with a discardability flag of true (0x1) in the RTP header extension. Similarly, in some implementations, NAL units with any other TID field value may be set with discardability flag of false (0x0) or with lowest priority in the RTP header extension.

Additionally, in some implementations, an HEVC codec may indicate a Random Access Skipped Leading (RASL) picture, which are pictures or frames that use pictures preceding a random access point in coding order for prediction and differential encoding. Such pictures may be corrupted if decoding begins at the random access point (and corresponding reference frame). Accordingly, in some implementations, RASL pictures may be discarded. HEVC provides mechanisms to enable specifying the conformance of a bitstream wherein the originally present RASL pictures have been discarded. Consequently, system components may discard RASL pictures, when needed, without worrying about causing the bitstream to become non-compliant. In some such HEVC implementations, NAL units with Type field value equal to 8 or 9 may be sent with a discardability flag in the RTP header extension set to true (0x1) or set with lower priority in the RTP header extension. NAL units with any other Type field value may be sent with a discardability flag in the RTP header extension set to false (0x0) or with a higher priority in the RTP header extension.

Similarly, implementations of the VVC codec may identify RASL pictures that may be safely discarded. VVC provides mechanisms to enable specifying the conformance of a bitstream wherein the originally present RASL pictures have been discarded. Consequently, system components may discard RASL pictures, when needed, without worrying about causing the bitstream to become non-compliant. Some implementations of the VVC codec use a NAL unit header 600 as shown in the illustration of FIG. 6. In such implementations, NAL units with Type field value equal to a predetermined value, such as 3, may be sent with a discardability flag in the RTP header extension set to true (0x1) or set with lower priority in the RTP header extension. NAL units with any other Type field value may be sent with a discardability flag in the RTP header extension set to false (0x0) or with a higher priority/importance in the RTP header extension.

Referring briefly back to FIG. 4, a NAL Reference ID or NRI field of 0 x00 indicates that the contents of the NAL unit is not used to reconstruct reference pictures for inter picture prediction (a value other than 0x00 indicates that the NAL unit is a reference picture or frame, or that the decoding of the NAL unit is required to maintain the integrity of the reference pictures). When the field is 0 and the NAL unit is not used to reconstruct reference pictures, the unit may be discarded without risking the integrity of the reference pictures. Accordingly, in such instances, NAL units with an NRI field value 0x00 may be sent with a discardability flag in the RTP header extension set to true (0x1) or set with lower priority in the RTP header extension. All other NAL units with an NRI field value greater than zero may be sent with a discardability flag in the RTP header extension set to false (0x0) or with a higher priority/importance in the RTP header extension.

Accordingly, in various implementations, the type and TID or NRI fields of the NAL unit header 400, 500, 600 in the payload of the RTP packet may be used to determine the importance of a NAL unit to decoding, with the least important NAL units set to a lowest priority in the RTP header extension and, in some implementations, marked for potential discarding in the RTP header extension if network conditions require it.

Configuration details of the PDU Set RTP header extension may need to be communicated between application servers (ASs) and user plane functions (UPFs), and/or among other nodes, including intermediary notes. For a given QoS flow and/or service data flow (SDF), a node providing an application function (AF) may configure PDU set information RTP HE usage in the RTP session. This may be done via a node providing a policy control function (PCF), and may be, for example, via a network exposure function (NEF). PDU set information RTP HE usage is negotiated between the AS and AF through an M3 interface or reference point, configured in the PCF (e.g. in the policy and charging control (PCC) rule), transferred by the PCF to a session management function (SMF) (e.g. in the PCC rule), and transferred by the SMF to UPF (e.g. in an N4 message). Each of these nodes may be provided by different computing devices or, in many implementations, one or more of the nodes or functions maybe provided by the same computing device. Accordingly, the communications between nodes may comprise broadcast communications, or may comprise communications via APIs or procedure calls between functional nodes within a computing system.

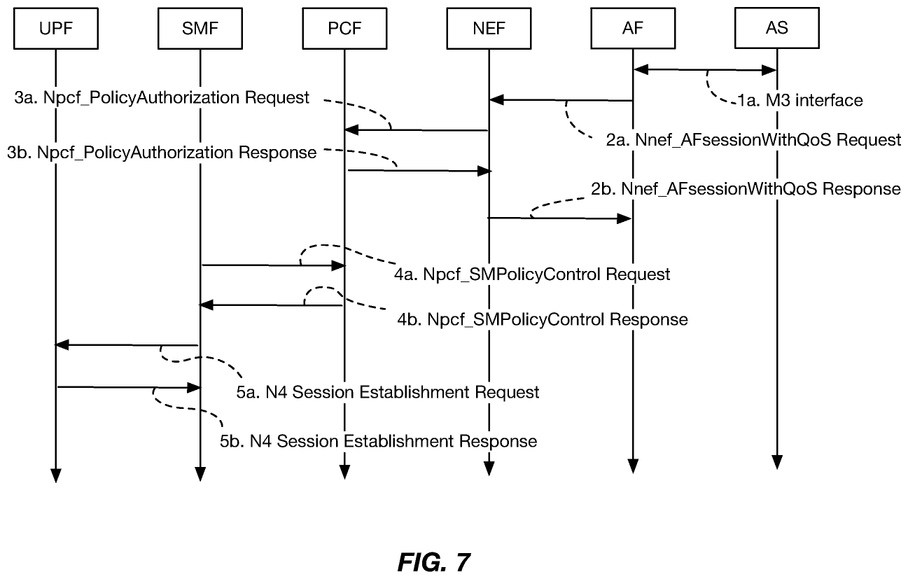

FIG. 7 is an illustration of an example procedure for configuring a UPF with PDU set information RTP HE usage. at 1a, an Application Server (AS) and an Application Function (AF) may negotiate the usage of RTP HE for transmitting the PDU set information between the AS and the User Plane Function (UPF) during a media session and informs the network about the support for PDU set information. For example, the negotiation may specify the type of header extension (e.g. one-byte header format; two-byte header format; bit depth; etc.). In some implementations, the information specified may include NAL Unit header types (e.g. which header or headers of the examples of FIGS. 4-6 are being utilized). In some implementations, the information of the RTP header extension ID generated in the RTP Session creation time may be signaled to the AF so that this information is carried to the UPF through the Policy Control Function (PCF) and Session Management Function (SMF). In another implementation, the RTP header extension ID is generated and signaled by the AF to the AS and this ID is used by the AS during the RTP Session creation time.

At 2a, in some implementations, the AF may invoke an API (e.g. an Nnef_AFsessionWithQOS request) to provide the NEF with the usage of PDU set information RTP HE (e.g. header type, bit depth, NAL unit types, or any combination of these or other information). At 2b, the NEF may respond to the API call (e.g. an Nnef_AFsessionWithQoS response). In various implementations, the response may indicate acceptance or acknowledgement, rejection (e.g. due to lack of support or an error), that the information has been passed further along, etc.

At 3a, in some implementations, the NEF may invoke an API (e.g. Npcf_PolicyAuthorization request) to provide the PDU set information RTP HE to the PCF. In some implementations, the PCF may use the PDU set information RTP HE presence in the media packets to construct a PCC Rule, which may include PDU set information RTP HE usage information as discussed above. At 3b, the PCF may respond to the API call (e.g. Npcf_PolicyAuthorization response) with an acknowledgement, error, further configuration parameters, or any other such information.

At 4, the PCF may send the PCC Rule to the SMF. In some implementations (e.g. “pull” implementations), the PCF may send the PCC rule to the SMF when the SMF invokes an API (e.g. Npcf_SMPolicyControl) requesting the PCC rule (e.g. as shown in 4a, 4b). For example, the SMF may invoke Npcf_SMPolicyControl during PDU Session Establishment and may transmit a request at 4a to the PCF, which may respond with the rule at 4b. Alternatively, in some implementations (e.g. “push” implementations), such as if the PDU Session has already been established when the PCF creates the PCC Rule, the PCF may use a notify operation of the Npcf_SMPolicyControl API to forward the PCC rules to the SMF. In some implementations, this may result in reversing the direction of the arrows at 4a, 4b, with the SMF responding at 4b with an acknowledgement of receipt of the rules. In still other implementations, the notify operation may occur first, with the PCF notifying the SMF that updated rules are available, triggering the SMF to transmit the Npcf_SMPolicyControl Request at 4a. Accordingly, sending the PCC Rules to the SMF may be initiated by the PCF or the SMF (e.g. “pull” operations, “push” operations, “notify and pull” operations, etc.).

At 5a, the SMF may send the PDU set information RTP HE usage information to the UPF in an N4 message (e.g. N4 Session Establishment Request) and may receive a response at 5b (e.g. N4 Session Establishment response), which may include an acknowledgement, further configuration information, etc.

As discussed above, in many implementations, the RTP header extensions may be used to signal PDU sequence numbers (PSN) and/or PDU Set sequence numbers (PSSN). In the example implementations 200, 300 of FIGS. 2 and 3, these numbers are 8 bits in length. However, this may be insufficient for some implementations of communications of media data.

For example, in many implementations, the bit-depth for a PSSN field is decided mostly based on the number of slices present in a frame. Slices may refer to a portion (e.g. a rectangular region, tile, etc.) of a picture, and may be based on coding true units, macroblocks, raster-scan tiles, etc., depending on the codec utilized. When a greater number of slices in a frame are present, a higher bit-depth is required for the PSSN. The maximum number of slices for are 1000 for VVC, 600 for HEVC, and 5802 for H. 264. Extending the PSSN to 10 bits may allow independent representation of 1000 slices.

In many implementations, the bit-depth for a PSN field may be decided based on the possible maximum size of a PDU set. When a frame is coded with a single slice, that data is encapsulated into a single PDU set. The number of PDUs required to encapsulate such a frame is high and the required number for PSN is also high in this case.

In some implementations, the number of slices per picture may be configured in a picture parameter set (PPS). In some implementations, a 1-bit field(S) may be used to signal whether or not the number of slices present in a frame are less than 32. For example, in some implementations, when the number of slices are less than 32, the S bit may be set to 1. When the number of slices is more than 32, the S bit may be set to 0.

Accordingly, in such implementations, when the number of slices is less than 32 (S bit is set to 1), 8 bits can be allocated to the PSN field, and 8 bits can be allocated to the PSSN field. Considering an MTU size of 1200 bytes in an RTP packet, with 8 bits allocated for the PSN field, we can transmit a maximum of 307,200 (2 Pow (8)*1200) bytes for a frame or slice. When fewer than 32 slices per frame are used, 5 bits may be enough to uniquely represent the PDU sets present in a frame. The additional 3 bits in the 8-bit PSSN field may be used to uniquely represent PDU sets present in multiple frames when they are transmitted together or as a burst.

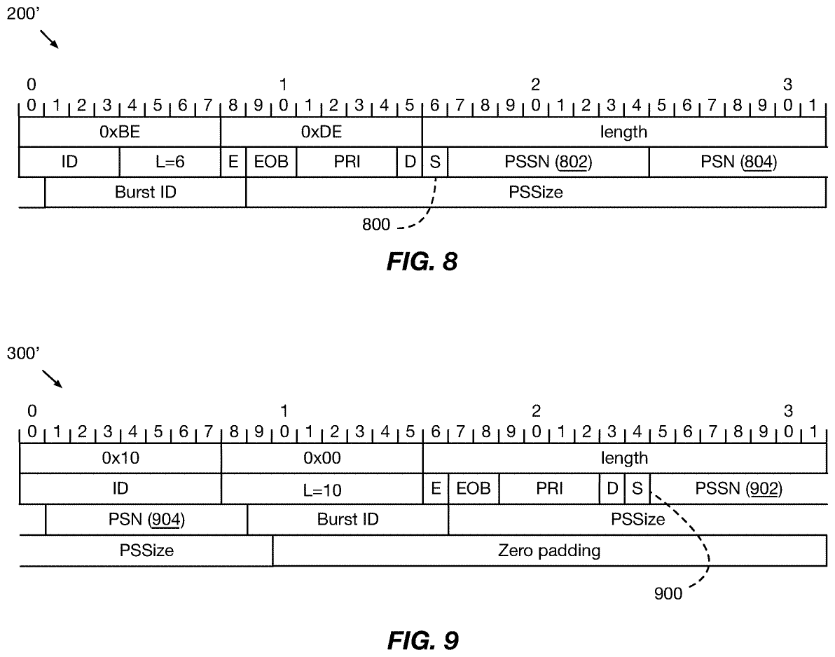

FIGS. 8 and 9 are examples of a RTP header extension using a one-byte header format 200′ and two-byte header format 300′ with slice number signaling, according to some embodiments. The slice field 800, 900 may comprise a one-bit flag set to 1 to indicate fewer than 32 slices, or to 0 to indicate 32 or more slices. In the examples 200′, 300′, the flag is set to 1, and accordingly, an 8-bit PSSN field (802, 902) and an 8-bit PSN field (804, 904) may be used.

When the number of slices is more than 32, 10 bits may be allocated to the PSSN, and 6 bits may be allocated to the PSN. Considering an MTU size of 1200 bytes in an RTP packet, and with 6 bits allocated for the PSN field we can transmit a maximum of 76,800 (2 Pow (6)*1200) bytes for a slice. When more than 32 slices per frame are used, more than 5 bits are required to represent uniquely the PDU sets present in a frame. The PSSN field with 10 bits may be used to uniquely represent the PDU sets present in multiple frames when they are transmitted together or as a burst.

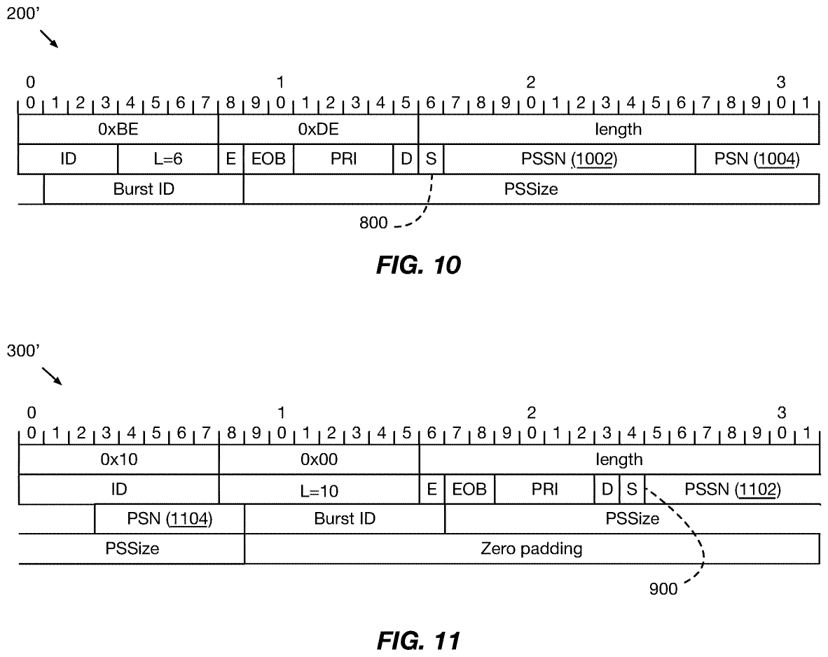

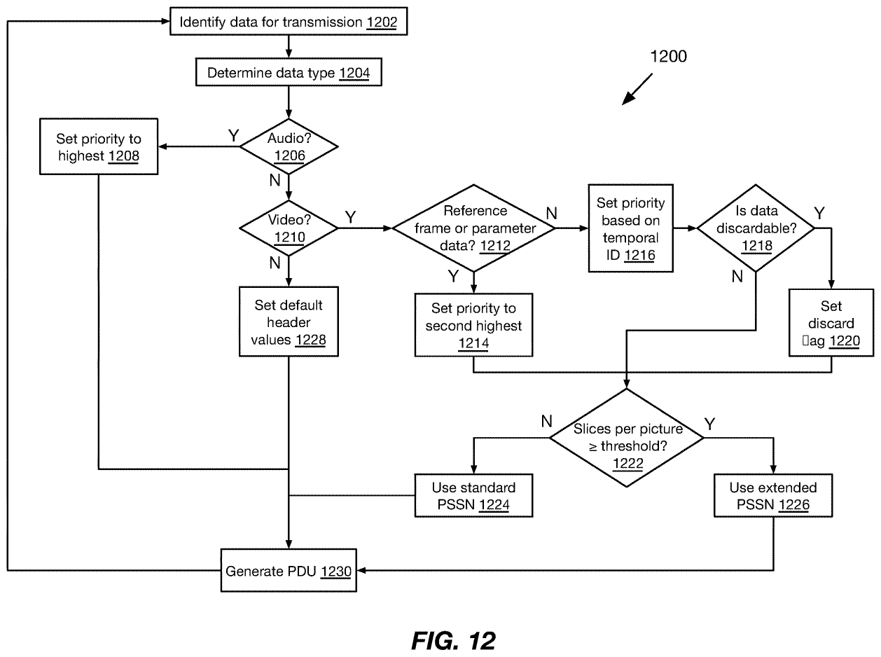

FIGS. 10 and 11 are examples of a RTP header extension using a one-byte header format 200″ and two-byte header format 300″ with slice number signaling, according to some embodiments. The slice field 1002, 1102 may comprise a one-bit flag set to 1 to indicate fewer than 32 slices, or to 0 to indicate 32 or more slices. In the examples 200″, 300″, the flag is set to 0, and accordingly, a 10-bit PSSN field (1002, 1102) and an 6-bit PSN field (1004, 1104) may be used.

FIG. 12 shows a flow chart of a method 1200 for signaling PDU set information via an RTP header extension, according to some embodiments. At 1202, a device such as a WTRU, computing device, encoder, media source device, streaming service, wireless gateway, or any other type and form of device, may identify data for transmission. The data may be stored in memory of the device, may be retrieved from another device, or may be generated by the device or another device.

At 1204 in some implementations, the device may determine a type of the data. The type of data may comprise audio data, video data (including augmented, virtual, or extended reality data), or any other type and form of data. In some implementations, determining the type of the data may comprise identifying a session or application layer header or payload indicating the type of data, or a header of a bitstream indicating the type of data. Audio and video data may be encoded via various encoders, which may be identified in a header of an application layer packet or bitstream, for example.

At 1206 in some implementations, the device may determine if the data is real-time audio data, such as streaming audio, voice-over-Internet-Protocol (VoIP) audio data, or any other type and form of real-time audio data. If so, at 1208, an importance or priority of the data may be set to a highest value (which may be a lowest actual value, such as 0x00, depending on implementation).

If the data is not audio data, at 1210 in some implementations, the device may determine if the data is video data. For example, the data may comprise encoded frames or portions of frames of a video bitstream. The video data may be prerecorded or may be generated live or in real-time, such as video conferencing or live streaming video data, augmented or extended reality data, etc. If so, at 1212 in some implementations, the device may determine if the data is a reference frame (e.g. I-frame or frame used for prediction or differential encoding of other frames, but which relies on no other frames itself for encoding) or a parameter set for decoding the video data. If so, at 1214 in some implementations, an importance or priority of the data may be set to a second highest value (which may be a second lowest actual value, such as 0x01, depending on implementation). If not, at 1216 in some implementations, an importance or priority of the data may be set proportional (or inversely proportional, depending on implementation) to a temporal identifier of the video data (such that video data having a highest or maximum temporal identifier have a lowest importance or priority).

At 1218 in some implementations, the device may determine if the data is discardable. Video data may be discardable in various implementations if it has a highest or maximum temporal identifier, if it is not used to reconstruct reference pictures, if it is a RASL picture, or any other type and form of video frame or picture (or portion of a frame or picture) that may be discarded without affecting the decoding or rendering of other video frames or pictures, or causing the bit-stream to be non-compliant. In some implementations, this may be identified based on a type field or temporal identifier field in a header of a NAL unit. If the data may be discarded, at 1220 in some implementations, a discard flag may be set or set with lower importance or priority in the RTP header extension.

At 1222 in some implementations, a number of slices per picture or frame of the video may be identified and compared to a threshold. The number of slices may be identified in a picture parameter set (PPS) of the video data, in some implementations. If the number of slices does not exceed a threshold, then at 1224 in some implementations, a standard length field may be used for a PDU Set sequence number (PSSN), such as 8 bits, and 8 bits may be used for a PSU sequence number (PSN). If the number of slices does exceed the threshold, then at 1226 in some implementations, an extended length field may be used for the PSSN and the PSN maybe accordingly shortened (e.g. adding two bits to the PSSN and removing two bits from the PSN, for example, or any other similar exchange).

In some implementations, if the data is neither audio nor video data, default or other header values may be used at 1228.

At 1230, a PDU and/or PDU set may be generated according to the various determined header values, including priority, discardability, and/or PSSN and PSN length.

Accordingly, implementations of the systems and methods discussed herein provide for signaling PDU set information via a RTP header extensions. Similar header extensions may be used with other protocols in various implementations to achieve the same benefits. For example, implementations of the systems and methods discussed herein provide for signaling PDU set information related to set importance or priority; discardability, including syntax, semantics and guidelines of discardability flags; and how to handle variable length fields such as PDU sequence numbers and/or PDU set sequence numbers.

In a first aspect, the present disclosure is directed to a method for packet data unit prioritization. The method includes identifying, by a wireless transmit/receive unit (WTRU), data for transmission. The method also includes determining, by the WTRU, a priority of the data transmission relative to other data transmissions by the WTRU based on a type or contents of the data for transmission. The method also includes generating, by the WTRU, a packet data unit (PDU) set comprising a plurality of PDUs including the identified data for transmission, wherein each PDU of the PDU set comprises a header value that indicates a priority corresponding to the determined priority. The method also includes transmitting, by the WTRU, the generated PDU set.

In some implementations, determining the priority of the data transmission includes determining that the data comprises a reference frame of a video; and selecting a priority higher than a priority for data including a non-reference frame of the video. In some implementations, determining the priority of the data transmission includes determining that the data comprises a parameter set for decoding or presenting a video; and selecting a priority higher than a priority for data including a non-reference frame of the video. In some implementations, the method includes determining, by the WTRU, a number of slices per picture of a frame of video of the identified data for transmission exceeds a threshold; and generating the PDU set further includes setting a header value in each PDU of the PDU set that indicates the number of slices per picture exceeds the threshold; in such implementations, each PDU of the PDU set includes a header field indicating a PDU set sequence number with a greater number of bits than a header field indicating a PDU sequence number.

In some implementations, determining the priority of the data transmission includes determining that the data comprises real-time audio data; and selecting a priority higher than a priority for data lacking real-time audio data.

In some implementations, the method includes identifying, by the WTRU, second data for transmission; determining, by the WTRU, a priority of the second data transmission relative to other data transmissions by the first WTRU based on a type or contents of the second data for transmission, the priority of the second data lower to the other data transmissions; and generating, by the WTRU, a second PDU set comprising a second plurality of PDUs including the identified second data for transmission, wherein each PDU of the second PDU set comprises a header value that indicates a discardability, lower importance, or lower priority of the second PDU set.

In a further implementation, determining a priority of the second data transmission includes determining that the second data comprises a non-reference frame of a video. In another further implementation, determining a priority of the second data transmission includes determining that the second data comprises a temporal identifier having a maximum value. In still another further implementation, determining a priority of the second data transmission includes determining that the second data comprises a non-reference frame of a video associated with a subsequent reference frame of the video. In another further implementation, the header value that indicates a discardability, lower importance, or lower priority of the second PDU set is a header extension flag or an importance field of a header extension. In a still further implementation, the header value is received, by the WTRU, from an application function or application server. In yet another further implementation, the method includes discarding, by the WTRU, the second PDU set without transmitting the second PDU set, responsive to detection of a network condition meeting a discard policy.

In another aspect, the present disclosure is directed to a wireless transmit/receive unit comprising one or more processors configured to perform any of the above-discussed embodiments of methods. In still another aspect, the present disclosure is directed to a network device comprising one or more processors configured to perform any of the above-discussed embodiments of methods. In still another aspect, the present disclosure is directed to a circuit configured to perform any of the above-discussed embodiments of methods. In still another aspect, the present disclosure is directed to a non-transitory computer-readable medium comprising instructions that, when executed by one or more processors of a computing device, cause the one or more processors to perform any of the above-discussed embodiments of methods.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for packet data unit prioritization, comprising:
identifying, by a wireless transmit/receive unit (WTRU), data for data transmission;
determining, by the WTRU, a priority of the data transmission relative to other data transmissions by the WTRU based on a type or contents of the data for transmission, wherein determining the priority of the data transmission includes determining that the data comprises real-time audio data and selecting a priority higher than a priority for data lacking real-time audio data;
generating, by the WTRU, a packet data unit (PDU) set comprising a plurality of PDUs including the identified data, wherein each PDU of the PDU set comprises a header value that indicates a priority corresponding to the determined priority; and
transmitting, by the WTRU, the generated PDU set.

2. The method of claim 1, further comprising:
identifying, by the WTRU, second data for second data transmission;
determining, by the WTRU, a priority of the second data transmission relative to other data transmissions by the WTRU based on a type or contents of the second data for transmission, the priority of the second data lower than the priority of the other data transmissions; and
generating, by the WTRU, a second PDU set comprising a second plurality of PDUs including the identified second data, wherein each PDU of the second PDU set comprises a header value that indicates a discardability, lower importance, or lower priority of the second PDU set.

3. The method of claim 2, wherein determining a priority of the second data transmission comprises:
determining that the second data comprises a non-reference frame of a video.

4. The method of claim 2, wherein determining a priority of the second data transmission comprises:
determining that the second data comprises a temporal identifier having a maximum value.

5. The method of claim 2, wherein determining a priority of the second data transmission comprises:
determining that the second data comprises a non-reference frame of a video associated with a subsequent reference frame of the video.

6. The method of claim 2, wherein the header value that indicates a discardability, lower importance, or lower priority of the second PDU set is a header extension flag or an importance field of a header extension.

7. The method of claim 6, wherein the header value is received, by the WTRU, from an application function or application server.

8. The method of claim 2, further comprising discarding, by the WTRU, the second PDU set without transmitting the second PDU set, responsive to detection of a network condition meeting a discard policy.

9. The method of claim 1, wherein determining the priority of the data transmission comprises:
determining that the data comprises a reference frame of a video; and
selecting a priority higher than a priority for data including a non-reference frame of the video.

10. The method of claim 1, wherein determining the priority of the data transmission comprises:
determining that the data comprises a parameter set for decoding or presenting a video; and
selecting a priority higher than a priority for data including a non-reference frame of the video.

11. The method of claim 1, further comprising determining, by the WTRU, a number of slices per picture of a frame of video of the identified data exceeds a threshold;
wherein generating the PDU set further comprises setting a header value in each PDU of the PDU set that indicates the number of slices per picture exceeds the threshold; and
wherein, in each PDU of the PDU set, a header field indicating a PDU set sequence number has a greater number of bits than a header field indicating a PDU sequence number.

12.-15. (canceled)

16. The method of claim 1, wherein the header value and a header extension type are negotiated by an application function and application server.

17. The method of claim 1, further comprising signaling the header value and a header extension type to an application function or application server.

18. A wireless transmit receive unit (WTRU) comprising:
a processor; and
a transceiver communicatively coupled to the processor, the processor and transceiver configured to:
identify data for data transmission;
determine a priority of the data transmission relative to other data transmissions by the WTRU based on a type or contents of the data for transmission, wherein determining the priority of the data transmission includes determining that the data comprises real-time audio data and selecting a priority higher than a priority for data lacking real-time audio data;
generating a packet data unit (PDU) set comprising a plurality of PDUs including the identified data, wherein each PDU of the PDU set comprises a header value that indicates a priority corresponding to the determined priority; and
transmitting the generated PDU set.

19. The WTRU of claim 18, wherein the processor and transceiver are further configured to:
identify second data for second data transmission;
determine a priority of the second data transmission relative to other data transmissions by the WTRU based on a type or contents of the second data for transmission, the priority of the second data lower than the priority of the other data transmissions; and
generate a second PDU set comprising a second plurality of PDUs including the identified second data, wherein each PDU of the second PDU set comprises a header value that indicates a discardability, lower importance, or lower priority of the second PDU set.

20. The WTRU of claim 19, wherein determining a priority of the second data transmission comprises at least one of determining that the second data comprises a non-reference frame of a video, determining that the second data comprises a temporal identifier having a maximum value, and determining that the second data comprises a non-reference frame of a video associated with a subsequent reference frame of the video.

21. The WTRU of claim 19, wherein the header value that indicates a discardability, lower importance, or lower priority of the second PDU set is a header extension flag or an importance field of a header extension.

22. The WTRU of claim 21, wherein the header value is received from an application function or application server, and wherein the header value and a header extension type are negotiated by the application function and application server.

23. The WTRU of claim 19, wherein the processor and transceiver are further configured to discard the second PDU set without transmitting the second PDU set, responsive to detection of a network condition meeting a discard policy.

24. The WTRU of claim 18, wherein the processor and transceiver are further configured to signal the header value and a header extension type to an application function or application server.
